(19) United States
(12) Patent Application Publication
(10) Pub. No.: US 2002/0101688 A1
(43) Pub. Date: Aug. 1, 2002

(54) Hinge pivot for disc drive

(76) Inventors: Joseph Cheng-Tsu Liu, Singapore (SG); Xiong Liu, Singapore (SG); Michael Joo Chiang Toh, Singapore (SG); Choonkiat Lim, Singapore (SG); Kevin Arthur Gomez, Singapore (SG)

Correspondence Address: Jonathan E. Olson, Seagate Technology LLC, Intellectual Property- COL2LGL, 389 Disc Drive, Longmont, CO, 80503, US

(21) Appl. No.: 09/727,665

(22) Filed: Dec. 1, 2000

Related U.S. Application Data
(60) Provisional application No. 60/170,238, filed on Dec. 10, 1999.

(51) Int. Cl. G11B 5/55

(52) U.S. Cl. 360/265.2; 360/265.7

(57) ABSTRACT

A disc drive having an actuator assembly which includes an actuator arm and having a pivot cartridge which consists of a sleeve, a shaft and a hinge. The hinge is thin and short in the horizontal direction along the x-y plane and long in the vertical direction along the z-axis. The hinge engages the sleeve and the shaft with the ends of the hinge, allowing only the central part of the hinge configured to be flexible. The assembly of the pivot cartridge into the actuator assembly forces the actuator arm to rotate only about the z-axis.

This patent application claims priority from U.S. Provisional application No. 60/170,238 filed Dec. 10, 1999.

### FIELD OF THE INVENTION

The present invention relates generally to disc drives, and more particularly to a pivot cartridge which supports the rotary actuator of a disc drive.

### BACKGROUND OF THE INVENTION

It is a common practice of using the rotary actuator to position the magnetic transducer heads in disc drives. The rotary actuator is supported by a pivot cartridge and is driven by a voice coil motor.

A typical pivot bearing cartridge assembly consists essentially of a pivot bearing housing, a pivot bearing shaft and two preloaded bearings. In order to remove internal clearance, it is necessary to use a pair of bearings assembled on a shaft. The bearings are positioned so that each exerts a small axial force on the other. This force is known as pre-load and it eliminates the internal clearance of the bearing. This force has to be adjusted carefully to provide adequate dynamic properties yet without increasing the frictional resistance to rotation (torque) of the assembly to an unacceptable extent. This frictional torque arises from the fact that there are many points of contact in a pair of ball bearings. There is also a large ratio between the rotational velocity of the balls and that of the arm rotation. The net effect is that the frictional forces between the balls and the surfaces of the races on which they roll and which are very small, are greatly amplified and add together to produce a significant frictional resistance to rotation of the assembly. This form of frictional behaviour, which is non-linear, is known as “hysteresis”.

In order to assure proper servo-operation, ball bearings of high quality are required when assemble a disc drive. To ensure that reasonably low friction is maintained after the pivot has been assembled, the alignment of the bearings must be accurately maintained. This will require the shaft and the outer bearing housing to be machined under great precision and to be assembled under careful control. As a result, such ball bearing arrangements are expensive. Furthermore they are made of steel which tend to be heavy and will increase the moment of inertia of the actuator which determines how fast the transducer heads can be moved to the new data. Thus, ball bearing pivot cartridges tend to slow down the speed of performance of disc drive.

Designs of different pivot cartridges have been proposed to ease the assembly of parts. Such methods have been described in the specifications of U.S. Pat. No. 5,355,268 entitled “Disk Drive Knife Edge Pivot”, by Dieter M. Schuize, granted Oct. 11, 1994, U.S. Pat. No. 5,559,652 entitled “Disk Drive Rotary Actuator With Rocking Pivot”, by John S. Heath et al, granted Sep. 24, 1996, U.S. Pat. No. 5,757,588 entitled “Hard Disk Assembly Having a Pivot Bearing Assembly Comprising Fingers Bearing on a Shaft”, by Nils E. Larson, granted May 26, 1998 and U.S. Pat. No. 6,078,475 entitled “Low Friction Pivot for Rotary Actuator in Disk Drive”, by Drew Brent Lawson, granted Jun. 20, 2000. Although these patents are said to provide lower friction and to solve the need for ball bearing pivot cartridges, the pivot cartridges tend to consist of many assembled parts. Further, to construct these parts together tend to be complicated.

Unlike the existing pivot cartridges, an ideal pivot cartridge should be rigid in all degrees of freedom other than rotation about the z-axis. It should have a limited operating range and the full actuator strike should be less than 30°. It should also be low in cost, a low or predictable bias force. Lastly but not limited thereto, it should be lightweight.

There remains a need for an improved and cheaper pivot cartridge which has the potential to meet the above requirements and replace ball bearing pivot cartridges. It will be evident from the following description that the present invention offers this and other advantages.

### SUMMARY OF THE INVENTION

The present invention relates to a simple construction of a pivot cartridge which is inexpensive, has minimal or no displacing effect on the positioning of the actuator arm and which has negligible friction torque, so as to solve the need for ball bearing pivot cartridges and to aim to present an ideal pivot cartridge.

According to one aspect of the invention, there is provided a pivot cartridge in which a shaft is engaged to a sleeve via a hinge. Once engaged, all parts of the hinge are restricted with only the central part of the hinge configured to be flexible. The central part of the hinge, which is thin and short in the horizontal direction along the x-y plane and long in the vertical direction along the z-axis, serves to constrain all degrees of freedom of motion of the actuator arm. Thus, when the pivot cartridge is assembled into the actuator assembly, only rotation about the z-axis is allowed.

These and other features as well as advantages which characterize the present invention will be apparent upon reading of the following detailed description and review of the associated drawings.

### BRIEF DESCRIPTION OF DRAWINGS

FIG. 1 is an exploded view of a typical disc drive.

FIG. 2 shows a top view of a pivot cartridge where the hinge is engaged between the sleeve and the shaft in the present invention.

FIG. 3 shows an exploded perspective view of pivot cartridge in an assembling sequence in the present invention.

FIG. 4 shows a perspective view of the pivot cartridge rotatable in the z-direction.

FIG. 5 shows a top view of a disc drive where the pivot cartridge is assembled into the actuator arm of the disc in the present invention.

FIG. 6 is a graph which illustrates the low frequency gain of using a pivot cartridge of the present invention compared to that of using a ball bearing pivot cartridge with increasing number of track motion.

### DETAILED DESCRIPTION

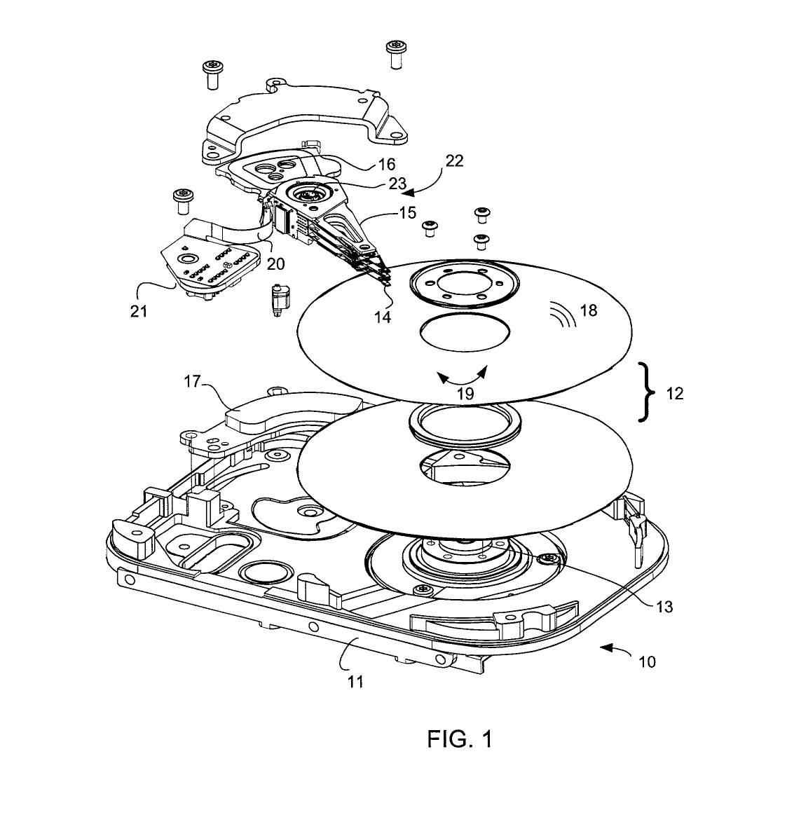

FIG. 1 shows an exploded perspective view of a disc drive 10. The disc drive 10, which has a housing base 11, includes a plurality of discs 12 mounted to rotate on a spindle motor 13. A plurality of transducer heads 14 is mounted to an actuator arm 15. The actuator arm 15 moves rotationally under the control of a voice coil motor. The voice coil motor includes a voice coil 16 and magnets 17 such that the transducer heads 14 can move to a desired trace 18 along a path 19. The transducer heads 14 pass via a flex circuit 20 and a connector 21 to and from on a controller board (not visible). An actuator assembly 22, which includes the actuator arm 15 and transducers heads 14, is mounted on the base 11 via a pivot cartridge 23.

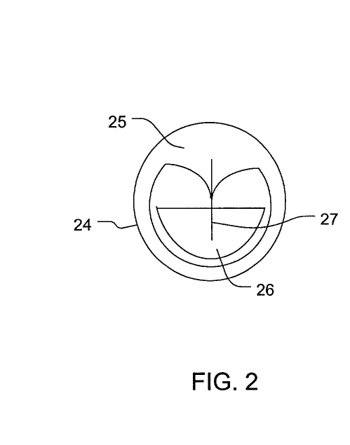

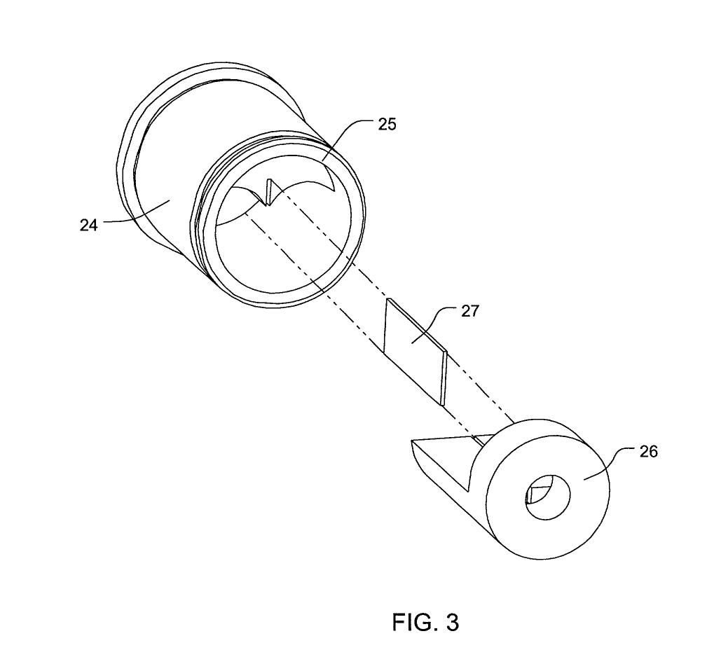

A preferred embodiment of the present invention is described below with reference to FIGS. 2-6. A pivot cartridge 24 in FIG. 2 consists of a sleeve 25, which is engaged to a shaft 26 through a hinge 27 as shown in the same figure. FIG. 3 shows an exploded perspective view of the pivot cartridge 24 with the sleeve 25, the shaft 26 and the hinge 27 in an assembling sequence. The hinge 27 is slotted by way of interference fit or welding between the sleeve 25 and the shaft 26 to provide the engagement.

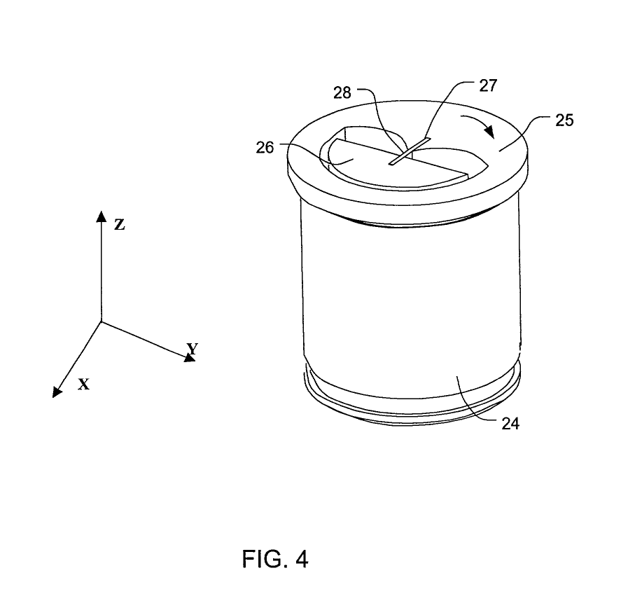

The central part 28 of the hinge 27 between the sleeve 25 and shaft 26 is short (in the x direction), thin (in the y direction), and tall (in the z direction). Preferably, the hinge 27 has a height at least 2-5 times its length and a length at least 2-5 times its thickness. As shown, the hinge 27 provides good rigidity in all degrees of relative motion between the sleeve 25 and the shaft 26 except their intended relative rotation (in the x-y plane as illustrated in FIG. 4). This is because all parts of the hinge 27 except the pliable central part 28 relatively fixed and restricted. This arrangement allows the pivot cartridge 24 to rotate about the z-axis as seen in FIG. 4. The hinge 27 may be made of plastic or steel but not limited thereto, although plastic is preferred because of its bendable and flexible quality.

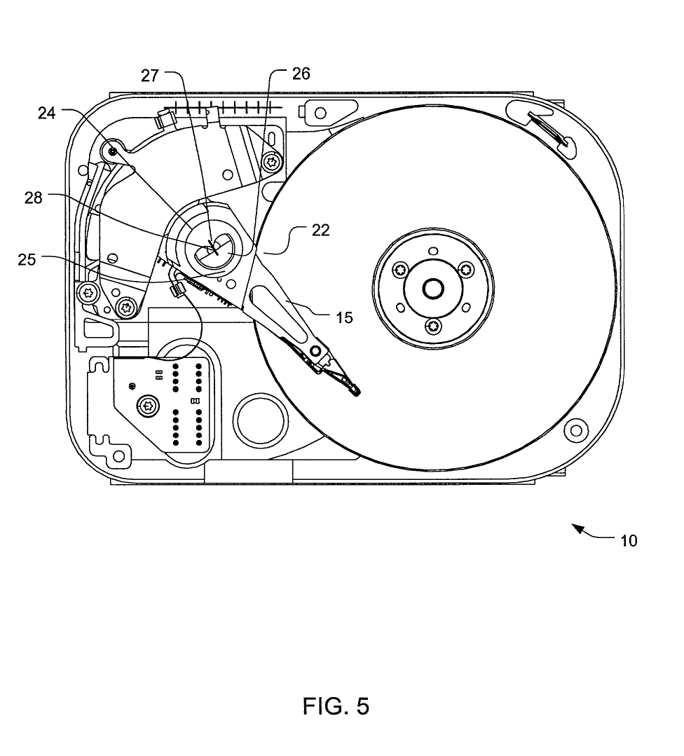

A hinge pivot cartridge 24 is assembled into the actuator arm assembly 22 of the disc drive 10 as shown in FIG. 5. A hysteresis test has been performed on the disc drive 10 with a ball bearing pivot cartridge assembled into the actuator arm assembly 22, such as the arrangement in FIG. 1. The same test is also carried out on the disc drive 10 with the hinge pivot cartridge 24 assembled into the actuator arm assembly 22. As the number of track motion increases, the low frequency gain of the movement of the actuator arm 15 is noted and fifteen tests are conducted and the results are as shown below:

TABLE 1
Low Frequency Gain of the Movement of the Actuator Arm
Using Ball Bearing Pivot Cartridge vs Hinge Pivot Cartridge (Units on dB)

| | No. of | Ball Bearing | Hinge |
|---|---|---|---|
| | Track | Pivot | Pivot |
| Test Run | Moved | Cartridge | Cartridge |
| 1 | 0.2 | 64.0 | 57.1 |
| 2 | 0.5 | 64.3 | 57.3 |
| 3 | 1 | 65.6 | 57.4 |
| 4 | 2 | 68.0 | 57.5 |
| 5 | 3 | 70.3 | 57.5 |
| 6 | 4 | 72.1 | 57.7 |
| 7 | 5 | 73.4 | 57.8 |
| 8 | 6 | 74.3 | 58.0 |
| 9 | 7 | 75.3 | 58.1 |
| 10 | 8 | 76.4 | 58.3 |
| 11 | 9 | 77.4 | 58.4 |
| 12 | 10 | 78.2 | 58.6 |
| 13 | 12 | 78.8 | 58.8 |
| 14 | 13 | 79.3 | 58.9 |
| 15 | 14 | 79.6 | 59.1 |

| | | |
|---|---|---|
| Difference between | 15.6 | 2 |
| maximum and minimum | | |

From the above results, it is evident that using the hinge pivot cartridge 24, its low frequency gain valve is relatively constant and the difference between the maximum and minimum valves is only 2 dB, whereas to use the ball bearing pivot cartridge 23, the difference of the two values is 15.6 dB. For using the ball bearing pivot cartridge 23, its low frequency gain valve tends to increase as the number of track motion increases. This change in gain is due to friction torque hysteresis effect in the ball bearing pivot cartridge. This is not observed in the hinge pivot cartridge.

As the hinge 27 will generate bias force when it is assembled into the actuator arm 15 of the disc drive 10, a bias force test is also carried out using a torque tester. The maximum bias force that is generated by the hinge 27 is less than 4.0×10⁻³ Nm, it can however be entirely compensated by the servo control.

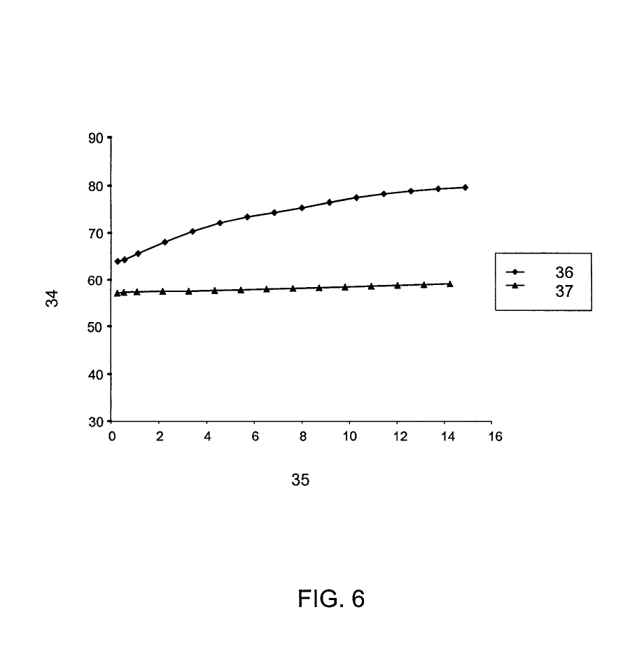

FIG. 6 is a graph, which measures, Gain (dB) 34 against the actuator movement 35. This is a graph illustration using the results of Table 1 to show the difference in the low frequency gain between using the ball bearing pivot cartridge and using the hinge pivot cartridge for positioning the actuator arm of a disc drive.

The Gain (dB) 34 is the logarithm of the actuator transfer function which is the amount of output per unit of input supplied and may be expressed as follows:

Gain (dB)=log|(output/input)|where input is the current supplied to the voice coil motor which drives the actuator assembly and output is measured in angular displacement of the actuator arm.

Due to the nonlinear or hysteresis behaviour of ball bearing pivot cartridge, when the ball bearing pivot cartridge 23 is in use, the low frequency gain will go up when the number of track motion increases as already evident in Table 1. This non-linear response affects the form of the transfer function. This is mainly due to the actuator's ball-bearing friction and especially affects positioning the actuator in small displacement. The low frequency gain in this case which is dependent on the movement of the actuator arm will change while positioning the actuator arm shown in line 36 in FIG. 6.

On the other hand, when the hinge pivot cartridge 24 is used, the movement of the actuator arm does not change the low frequency gain valve while positioning the actuator arm with different track numbers shown in line 37 in FIG. 6. As shown in Table 1, the low frequency gain is generally linear. It is therefore obvious that there is negligible friction torque and no hysteresis effect while using hinge pivot cartridge and thus, during servo design, the pivot can be treated as a linear system.

The present invention hence provides and combines the advantages of the ease of assembly of a pivot cartridge, the intended function of a pivot cartridge to allow rotation of the actuator arm about the z-axis as well as the effect of reducing the moment of inertia of the actuator and thus permitting higher servo gain and achieving faster access time.

A preferred device of the present invention (i.e. disc drive 10) comprises a housing base 11 supporting a spindle motor 15. The spindle motor 15 is mounted with a plurality of rotatable discs 12. An actuator assembly 22 mounted onto the housing base 11 consists of a plurality of transducer heads 14 to rotate on the discs 12. A pivot cartridge 24 assembled into the actuator assembly 22 comprises of a sleeve 25, a shaft 26 and a hinge 27. The hinge 27, which is thin and short in the horizontal direction along the x-y plane and long in the vertical direction along the z-axis, is engaged between the sleeve 25 and the shaft 26. While the parts of the hinge 27 that engaged to the sleeve 25 and the shaft 26 are restricted, the central part 28 of the hinge 27, which is not engaged, is flexible. This arrangement facilitates only the rotation of the pivot cartridge 24.

It is to be understood that even though numerous characteristics and advantages of various embodiments of the present invention have been set forth in the foregoing description, together with details of the structure and function of various embodiments of the invention, this disclosure is illustratively only, and changes may be made in detail, especially in the matters of structure and arrangement of parts within the principles of the present invention to the full extent indicated by the broad general meaning of the terms in which the appended claims are expressed. For example, the particular elements may vary depending on the particular application for the disc drive while maintaining substantially the same functionality without departing from the scope and spirit of the present invention. In addition, although the preferred embodiment described herein is directed to a disc drive, it will be appreciated by those skilled in the art that the teachings of the present invention can be applied to other systems, without departing from the scope and spirit of the present invention.

1. A pivot cartridge comprising:
a sleeve;
a shaft; and
a hinge engaged between the sleeve and the shaft to allow the shaft to rotate with respect to the sleeve.

2. A pivot cartridge as claimed in claim 1 in which the hinge includes a bendable portion that is elongated in a vertical direction parallel to an axis of rotation.

3. A pivot cartridge as claimed in claim 2 in which the hinge is at least three times longer in the vertical direction than in any horizontal direction.

4. A pivot cartridge as claimed in claim 1, wherein the hinge is made of plastic.

5. A disc drive comprising:
a housing base;
a spindle motor mounted on the housing base;
a plurality of rotatable discs mounted on the spindle motor;
an actuator assembly mounted on the housing base consists of a plurality of
transducer heads to rotate on the discs;
a pivot cartridge secured to the actuator assembly comprises:
a sleeve;
a shaft; and
a hinge engaged between the sleeve and the shaft to allow the pivot cartridge undergo a rotating motion.

5. A disc drive as claimed in claim 5, wherein the movable part of the hinge is thin and short in the horizontal direction along the x-y plane.

6. A disc drive as claimed in claim 6, wherein the movable part of the hinge is long in the vertical direction along the z-axis.

8. A disc drive as claimed in claim 7, wherein the hinge is made of plastic.

9. A disc drive having a pivot cartridge comprising:
a sleeve;
a shaft; and
means for securing the sleeve to the shaft to allow the pivot cartridge undergo rotating motion.
